(19) United States
(12) Patent Application Publication
(10) Pub. No.: US 2017/0262800 A1
(43) Pub. Date: Sep. 14, 2017

(54) APPARATUS AND METHOD OF SECURELY DELIVERING AND RECEIVING PACKAGES

(71) Applicants: Wayne Dorpfeld, Albion, NY (US); Steven Ferrarese, Rochester, NY (US); Kurt Scheuch, Hilton, NY (US)

(72) Inventors: Wayne Dorpfeld, Albion, NY (US); Steven Ferrarese, Rochester, NY (US); Kurt Scheuch, Hilton, NY (US)

(21) Appl. No.: 15/605,581

(22) Filed: May 25, 2017

Related U.S. Application Data
(63) Continuation-in-part of application No. 14/606,449, filed on Jan. 27, 2015.
(60) Provisional application No. 61/932,050, filed on Jan. 27, 2014.

(51) Int. Cl. G06Q 10/08

(52) U.S. Cl. CPC G06Q 10/0833; G06Q 10/0836

(57) ABSTRACT

An apparatus for securely delivering and receiving a package having a first receptacle with at least one sidewall, a roof and a platform contiguous with the at least one sidewall, the platform having a top surface and a bottom surface, and at least one open space between the roof and the top surface of the platform operatively arranged to receive mail or a package; and, a second receptacle including a first wall having a first upper edge and a first lower edge, a second wall having a second upper edge and a second lower edge, a third wall having a third upper edge and a third lower edge, and a fourth wall having a fourth upper edge and a fourth lower edge where the first wall, the second wall, the third wall, and the fourth wall are contiguous and arranged to create a closed space.

### CROSS-REFERENCE TO RELATED APPLICATIONS

This application is a continuation-in-part of U.S. application Ser. No. 14/606,449, which application was filed Jan. 27, 2015, which application claims the benefit under 35 U.S.C. §119(e) of U.S. Provisional Patent Application No. 61/932,050, filed Jan. 27, 2014, which applications are hereby incorporated by reference in their entirety.

### FIELD OF THE INVENTION

The present invention relates to an apparatus and method of securely delivering and receiving packages, specifically to an apparatus and method for reducing theft for home and business deliveries.

### BACKGROUND OF THE INVENTION

Internet sales have brought new life to what was the mail order industry. Online merchandise sales are currently growing at an unprecedented rate. The rise in internet sales has led to a proportionate rise in the amount of package delivery theft throughout the country. Every year, millions of packages delivered to homes and businesses are stolen before the rightful owner can receive them. During holiday seasons, e.g., November-December, reports of package theft skyrocket. Cyber Monday sales, Black Friday sales, and Christmas sales constitute multiple billions of dollars in gross sales revenue derived from personal purchases. During these seasons, millions of Americans report the theft of packages delivered to their homes.

Currently, packages are delivered by a courier, selected by the customer directly at the time of purchase or indirectly by buying products from companies that affiliate with a preassigned courier service. After the courier company receives the package/order, a tracking number is generated unique to that package/order, allowing the customer to watch the progress of their package from its starting point, e.g., a warehouse or distribution facility, to their home or business. In increasing frequencies, when the courier reaches the individual customer's home or business, the package is left outside of the home, e.g., next to the front door, on a porch, or tucked into a mailbox. Usually the package is left in a conspicuous area that can easily be seen from the road or sidewalk by a passerby. This creates a unique environment, not experienced in other forms of commercial retail, which invites thieves to follow delivery trucks during work hours and steal deliveries from unsuspecting victims.

Most couriers offer services to minimize theft of deliveries, e.g., allowing the entity that purchases the item to indicate that a signature is required by the homeowner or a representative living at the residence before the package can be successfully delivered. However, more often than not, the courier will deliver these packages at a time when no one is home to sign for them, i.e., normal business or office hours. The customer and courier remain in a cycle of attempt/failure until the customer and courier are at the home contemporaneously, or customer opts for another delivery method. This results in increased delivery time, and increased hassle on the part of the courier as well as the home owner/customer. Amazon currently offers a service “Amazon Locker” which allows customers to select one of several dozen locker locations to have packages delivered in a secure safe environment. To date, Amazon has installed nearly 70 lockers in locations all over the United States. Unfortunately, due to sparse placement of these facilities most Amazon customers will never be within 30 miles of an Amazon Locker.

Thus, there is a long felt need for an apparatus, system, and method for securely delivering packages that does not require a customer signature and does not leave the package vulnerable to easy theft.

### SUMMARY

According to the aspects illustrated herein, there is provided a device for receiving packages including: a first receptacle having at least one sidewall, a roof contiguous with the at least one sidewall, a platform contiguous with the at least one sidewall, the platform further comprising a top surface and a bottom surface, and at least one open space between the roof and the top surface of the platform, the at least one open space operatively arranged to receive mail or a package. The device further includes a second receptacle having a first wall with a first upper edge and a first lower edge, a second wall having a second upper edge and a second lower edge, a third wall having a third upper edge and a third lower edge, and a fourth wall having a fourth upper edge and a fourth lower edge wherein the first wall, the second wall, the third wall, and the fourth wall are contiguous and arranged to create a closed space.

According to the aspects illustrated herein, there is provided a method for securely delivering a package including: receiving an order for an item to be delivered to a recipient; obtaining a unique authentication code; delivering the item to a location corresponding to the recipient; unlocking a lock box at the location using the unique authentication code sent wirelessly to a locking mechanism within the lock box; and, depositing the item in the lock box.

According to the aspects illustrated herein, there is provided a method for securely receiving a package including: storing a first unique authentication code in at least one memory element within a locking mechanism of a lock box; receiving a second unique authentication code sent from a first handheld computer; storing the unique authentication code in the at least one memory element within the locking mechanism; comparing the first unique authentication code and the second authentication code; unlocking the locking mechanism of the lock box if the first unique authorization code and the second unique authorization code match; sensing with at least one sensor that the locking mechanism is disengaged when the lock box is opened; receiving the package within the lock box; sensing with at least one sensor that the locking mechanism is engaged when the lock box is closed; and, sending a confirmation via wireless communication to the first handheld computer that the lock box is closed.

These, and other objects and advantages, will be readily appreciable from the following description of preferred embodiments and from the accompanying drawings and claims.

### BRIEF DESCRIPTION OF THE DRAWINGS

The nature and mode of operation of the present disclosure will now be more fully described in the following detailed description of the embodiments taken with the accompanying figures, in which:

FIG. 1 is a front perspective view of a device for securely receiving packages;

FIG. 2 is a side schematic view of a device for securely receiving packages;

FIG. 3 is a front schematic view of a device for securely receiving packages;

FIG. 4 is a side cross-sectional view of a device for securely receiving packages taken generally along line 4-4 in FIG. 3;

FIG. 5 is a flow chart illustrating the steps of the method recited herein;

FIG. 6 is a flow chart illustrating the steps of the method recited herein;

FIG. 7 is a flow chart illustrating the steps of the method recited herein; and,

FIG. 8 illustrates a high level schematic view of the communication paths involved in implementing the method recited herein.

### DETAILED DESCRIPTION OF THE INVENTION

At the outset, it should be appreciated that like drawing numbers on different drawing views identify identical, or functionally similar, structural elements. While the embodiments are described with respect to what is presently considered to be the preferred aspects, it is to be understood that the invention as claimed is not limited to the disclosed aspect. The present invention is intended to include various modifications and equivalent arrangements within the spirit and scope of the appended claims.

Furthermore, it is understood that this disclosure is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

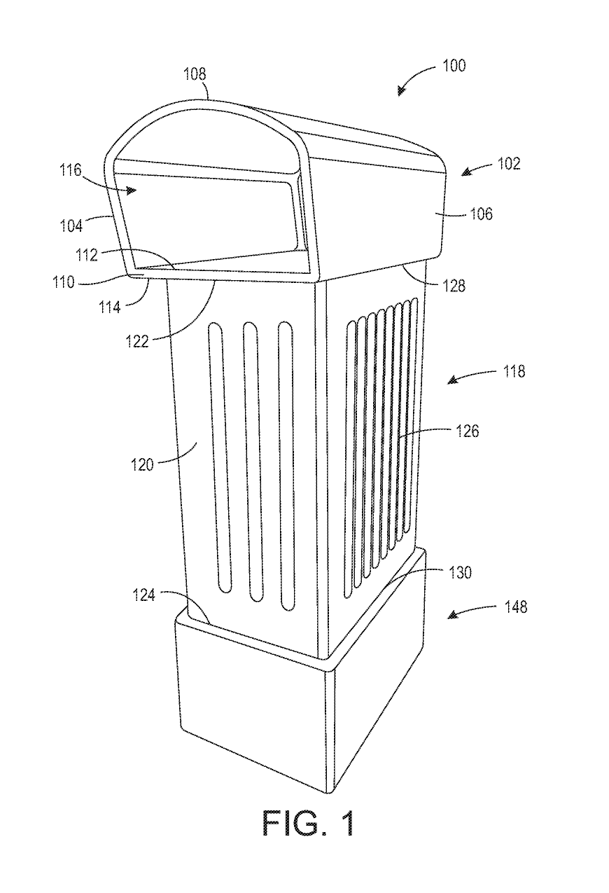

Adverting now to the Figures, FIG. 1 illustrates a front perspective view of an example embodiment of a device 100 for securely receiving packages. Device 100 includes first receptacle 102. First receptacle 102 further includes side wall 104, side wall 106, roof 108, and platform 110. Side wall 104 is contiguous, i.e., shares a common border with, both roof 108 and platform 110. Side wall 106 is also contiguous with roof 108 and platform 110. Platform 110 further includes top surface 112 and bottom surface 114. First receptacle 102 further includes an open space 116 arranged to receiving mail. It should be appreciated that, although side wall 104, side wall 106, roof 108, and platform 110 are described as discrete elements, device 100 can be formed as one continuous body with smooth transitions between these elements. Although in a preferred embodiment first receptacle 102 and all of its component parts, i.e., side wall 104, side wall 106, roof 108, and platform 110 are made of blow-molded plastic, first receptacle 102 and its component parts could also be made from injection-molded plastic, rotation-molded thermal plastic, steel, aluminum, or any other suitable material. Although not illustrated in the figures, first receptacle 102 can further include a door, hingedly secured to either: side wall 104, side wall 106, roof 108, or platform 110, and when in the closed position, contiguous with side wall 104, side wall 106, roof 108, and platform 110 and operatively arranged to provide a water-tight seal covering the opening of open space 116.

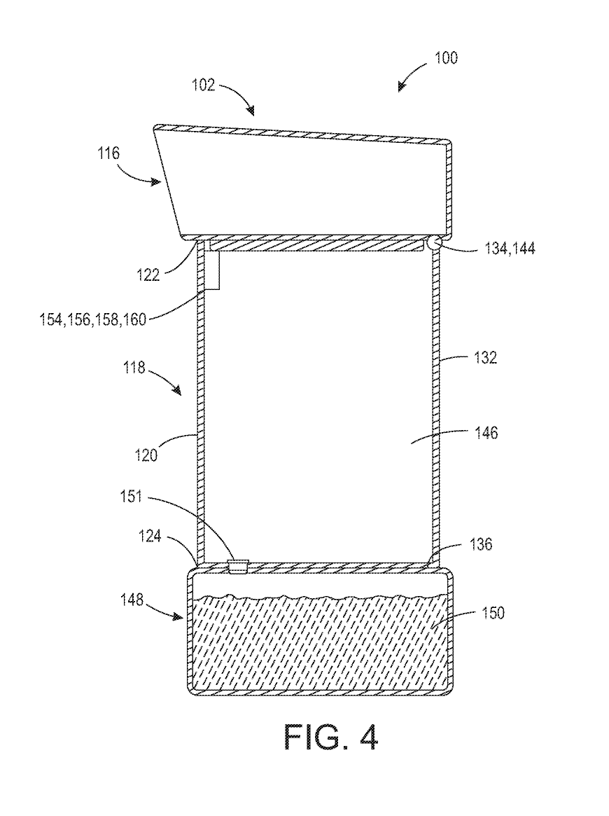

Device 100 further includes second receptacle 118. Second receptacle 118 includes: first wall 120 having first upper edge 122 and first lower edge 124; second wall 126 having second upper edge 128 and second lower edge 130; third wall 132 having third upper edge 134 and third lower edge 136 (illustrated in FIG. 3); fourth wall 138 having fourth upper edge 140 and fourth lower edge 142 (illustrated in FIG. 3); and, hinge 144 (illustrated in FIG. 4). First wall 120 is contiguous with second wall 126 and fourth wall 138. Second wall 126 is contiguous with first wall 120 and third wall 132. Third wall 132 is contiguous with second wall 126 and fourth wall 138. Fourth wall 138 is contiguous with first wall 120 and third wall 132. Although in a preferred embodiment second receptacle 118 and all of its component parts, i.e., first wall 120, second wall 126, third wall 132 and fourth wall 138 are made of blow-molded plastic, second receptacle 118 and its component parts could also be made from injection-molded plastic, rotation-molded thermal plastic, steel, aluminum, or any other suitable material.

Device 100 further includes base 148. Base 148 is fixedly secured to: first lower edge 124 of first wall 120; second lower edge 130 of second wall 126; third lower edge 136 of third wall 132; and, fourth lower edge 142 of fourth wall 138. Base 148 is operatively arranged to receive a ballast material 150 via port 151. Ballast material 150 can include sand, water, antifreeze, or any combination thereof, as well as other ballast materials known in the art. Base 148 can be filled with varying amounts of ballast material 150 to whatever amount is desired by a user to add sufficient stability to device 100.

When device 100 is completely assembled, i.e., first receptacle 102, second receptacle 118 and base 148 are all engaged, a closed space 146 is created between the top of base 148, first wall 120, second wall 126, third wall 132, fourth wall 138 of the second receptacle, and bottom surface 114 of platform 110 of first receptacle 102. Closed space 146 is operatively arranged to receive large packages, i.e., packages large enough that it would not be feasible to place them in opening 116 of first receptacle 102 without damaging the package contents.

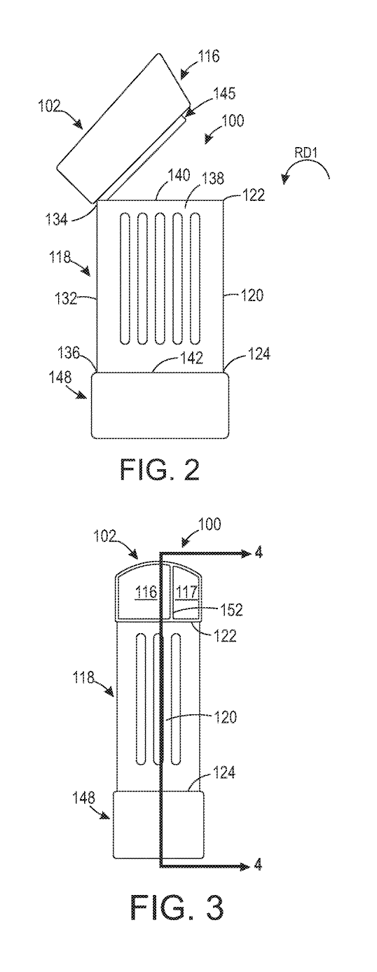

FIG. 2 illustrates a side schematic view of an example embodiment of device 100 for securely receiving packages. The embodiment of device 100 illustrated in FIG. 2 is substantially similar to the embodiment illustrated in FIG. 1. In this embodiment however, first receptacle 102 has been disengaged from its resting position on second receptacle 118. In this position a frictional engagement member 145 is clearly visible. Frictional engagement member 145 is fixedly secured to bottom surface 114 of first receptacle 102 and operatively arranged to frictionally engage with the upper edges (122, 128, 134, and 140) of the first, second, third, and fourth walls (120, 126, 132, and 138) of second receptacle 118. This frictional engagement keeps first receptacle 102 seated symmetrically on top of second receptacle 118 and prevents first receptacle 102 from being displaced horizontally relative to second receptacle 118. Additionally, this frictional engagement provides a water-tight seal between first receptacle 102 and second receptacle 118 that protects a deposited package from water damage after the item has been deposited.

FIG. 3 illustrates a front schematic view of an example embodiment of device 100 for securely receiving packages. The embodiment of device 100 illustrated in FIG. 3 is substantially similar to the embodiments illustrated in FIGS. 1 and 2. However, in this embodiment, first receptacle 102 has an additional element, i.e., dividing wall 152. Dividing wall 152 is fixedly secured within the open space between roof 108 and top surface 112 of platform 110. Dividing wall 152 creates a second open space 117. In this embodiment, open space 116 is operatively arranged to receive mail, e.g., letters, magazines, etc., and open space 117 is operatively arranged to receive a newspaper.

FIG. 4 illustrates a side cross-sectional view of an example embodiment of device 100 for securely receiving packages taken generally along line 4-4 in FIG. 3. As clearly depicted in FIG. 4, second receptacle 118 further includes hinge 144 and locking mechanism 154. Hinge 144 is operatively arranged between first receptacle 102 and second receptacle 118. A portion of hinge 144 is fixedly secured to bottom surface 114 of platform 110, and a portion of hinge 144 is fixedly secured to an inside surface of third wall 132 proximate to third upper edge 134 of second receptacle 118. Both portions of hinge 144 can be fixedly secured to these respective surfaces by any adhesive or fixation devices known in the art, e.g., glues, screws, bolts, etc. Hinge 144 operates to allow rotational movement of first receptacle in a first radial direction RD1 (as shown in FIG. 2) relative to second receptacle. Locking mechanism 154 further includes central processing unit 154 (CPU) and memory element 156. Memory element 156 and CPU 154 are operatively arranged to store and execute, respectively, computer readable instructions selected to perform the steps of the method recited infra. It should be appreciated that any locking mechanism capable of wireless communication can be used; however, in a preferred embodiment, the locking mechanism is a Phantom Lock such as the lock sold at http://phantomlock.com/ capable of Bluetooth® wireless communication with a smart phone, specifically wireless communication with a paired smart phone. When locking mechanism 154 is engaged (locked) first receptacle 102 is secured in the closed position illustrated in FIG. 4. When locking mechanism 154 is disengaged (unlocked) through wireless communication with a handheld computer 158, first receptacle 102 is free to rotate/pivot about hinge 144 in first radial direction RD1 relative to second receptacle 118, creating an opening to allow a user/courier to deposit or withdraw a package from closed space 146. Locking mechanism 154 is intended to be battery powered and can derive power from any battery known in the art. However, in a preferred embodiment the battery used is a 12-volt lithium ion battery (not illustrated) similar to the batteries used in portable handheld drills. This allows for quick replacement and charging should the battery need it. In a preferred embodiment the battery would be housed internally within second receptacle 118; however, it should be appreciated that the battery could be mounted externally to the second receptacle, or the device could be plugged into a wall outlet for power.

Furthermore, FIG. 4 illustrates closed space 146 within base 148. Base 148 is a hollow receptacle arranged to receive a ballast material through a port 151. Ballast material 150 could be any ballast material reasonably accessible to the average consumer such as sand, water, antifreeze, or any combination thereof. Ballast material 150 is added to base 148 of device 100 via port 151 prior to positioning device 100 for receipt of packages. Port 151 is illustrated as an aperture leading into the interior space of base 148 with a water-proof seal/cap component operatively arranged to prevent the ballast material 150 from leaking out of the aperture. The amount of ballast material 150 chosen is dependent on several environmental factors such as wind speed, available terrain gradation, etc. Base 148 does not have to be completely filled with ballast material 150. Further, it should be appreciated that, base 148 can be positioned with at least a portion of base 148 under the surface of the adjacent ground, i.e., buried several inches or completely such that less ballast material is needed to keep device 100 upright and balanced. The intended purpose of the addition of ballast material 150 into base 148 is to provide stability to device 100 in its upright position, as well as reduce the force necessary to lift device 100 from a fallen position, i.e., not in its upright position back into the upright position. It should be noted that water may not be a suitable ballast material in environmental conditions that experience extreme temperatures, e.g., freezing temperatures, without the addition of antifreeze. Although in a preferred embodiment base 148 is made of blow-molded plastic, base 148 could also be made from injection-molded plastic, rotation-molded thermal plastic, steel, aluminum, or other suitable material.

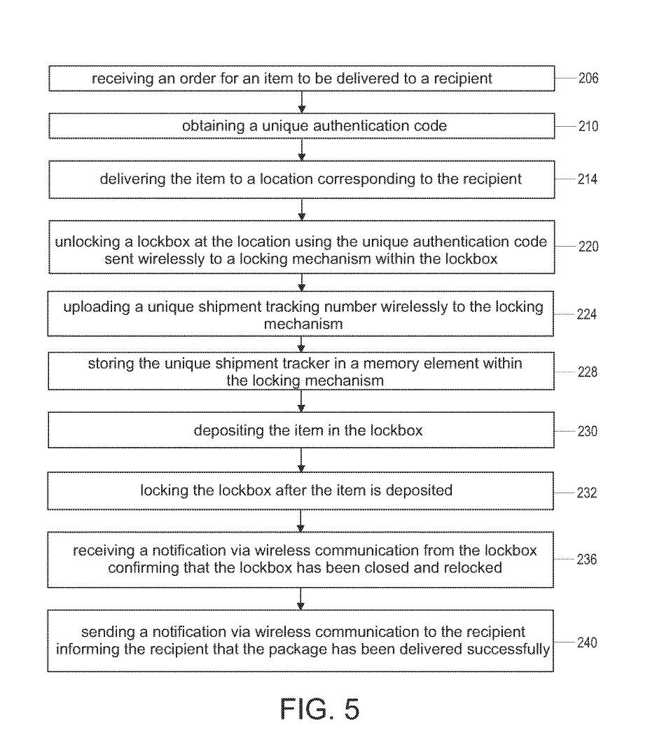

FIG. 5 illustrates the steps of the method recited herein. The steps of the method include receiving order 200 for item 202 to be delivered to recipient 204 (step 206); obtaining unique authentication code 208 (step 210); delivering item 202 to location 212 corresponding to recipient 204 (step 214); unlocking lock box 216 at location 212 using unique authentication code 208 sent wirelessly to locking mechanism 218 within lock box 216 (step 220); uploading unique shipment tracking number 222 wirelessly to locking mechanism 218 (step 224); storing unique shipment tracking number 222 in memory element 226 within locking mechanism 218 (step 228); depositing item 202 within lock box 216 (step 230); locking lock box 216 after item 202 is deposited (step 232); receiving notification 234 via wireless communication from lock box 216 confirming that lock box 216 has been closed and relocked (step 236); and, sending notification 238 via wireless communication to recipient 204 (step 240).

It should be appreciated that the steps of the method recited supra are illustrated from the perspective of a courier delivering the package to a wirelessly enabled lock box such as device 100 described supra. However, the method could be used on any wirelessly enabled lock box, e.g., a porch box with a wireless receiver/locking device, or a standard mail box which contains wirelessly enabled locking capabilities. The foregoing method includes steps taken by a courier when delivering a package wherein the courier is required to possess the unique identifying information of a particular wireless locking mechanism to gain initial access to the lock box.

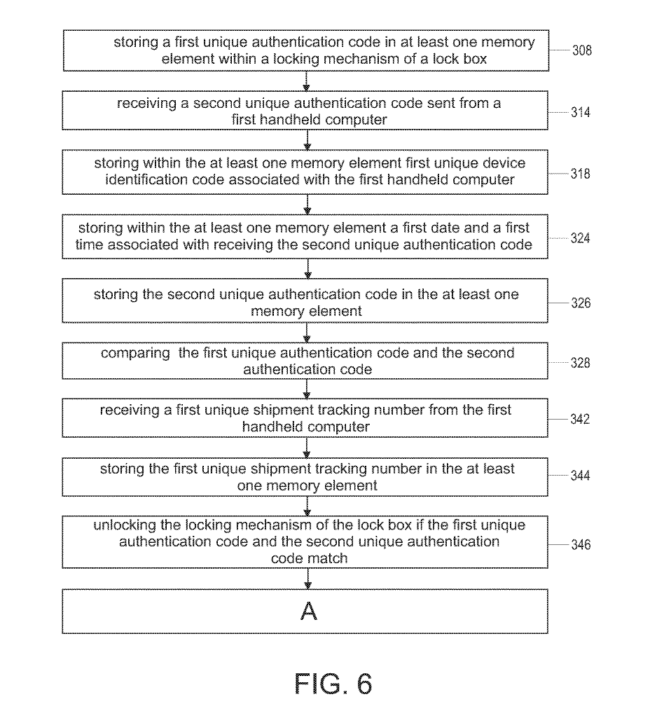

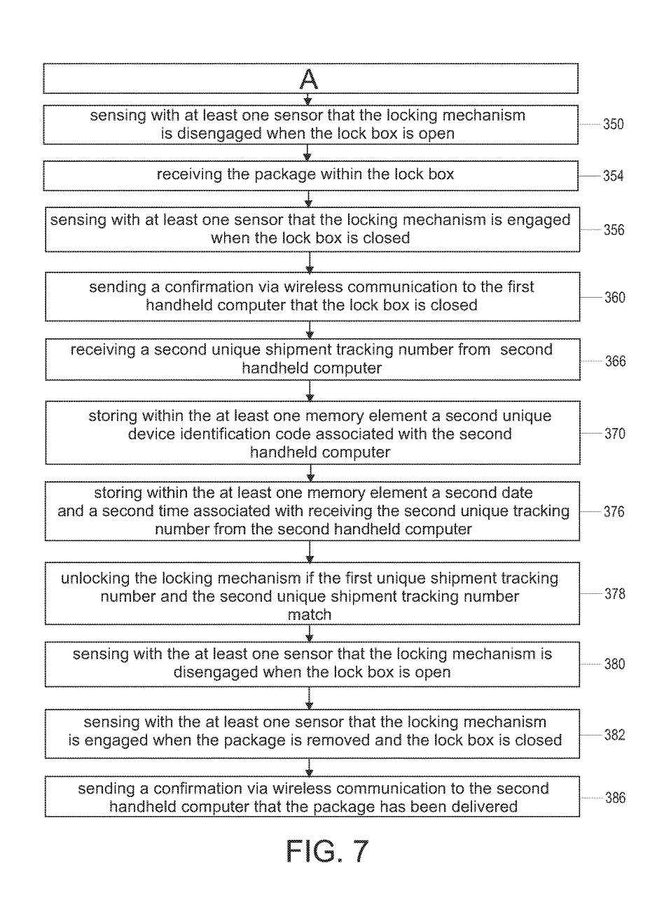

FIGS. 6 and 7 illustrate the steps of the method recited herein. The steps of the method include storing first unique authentication code 300 in at least one memory element 302 within locking mechanism 304 of lock box 306 (step 308); receiving second unique authentication code 310 sent from first handheld computer 312 (step 314); storing within at least one memory element 302 first unique device identification code 316 associated with first handheld computer 312 (step 318); storing within at least one memory element 302 first date 320 and first time 322 associated with receiving second unique authentication code 310 (step 324); storing second unique authentication code 310 in at least one memory element 302 (step 326); comparing first authentication code 300 and second authentication code 310 (step 328); receiving first unique shipment tracking number 340 from first handheld computer 312 (step 342); storing first unique shipment tracking number 340 in at least one memory element 302 (step 344); unlocking locking mechanism 304 if first unique authentication code 300 and second unique authentication code match 310 (step 346); sensing with at least one sensor 348 that locking mechanism 304 is disengaged (step 350); receiving package 352 within lock box 306 (step 354); sensing with at least one sensor 348 that lock box 306 is closed (step 356); sending confirmation 358 via wireless communication to first handheld computer 312 that lock box 306 is closed (step 360); receiving second unique shipment tracking number 362 from second handheld computer 364 (step 366); storing within at least one memory element 302 second unique device identification code 368 associated with second handheld computer 364 (step 370); storing within at least one memory element 302 second date 372 and second time 374 associated with receiving second unique tracking number 362 from second handheld computer 364 (step 376); unlocking locking mechanism 304 if first unique shipment tracking number 340 and second unique shipment tracking number 362 match (step 378); sensing with at least one sensor 348 that locking mechanism 304 is disengaged when lock box 306 is open (step 380); sensing with at least one sensor 348 that locking mechanism 304 is engaged when package 352 is removed and lock box 306 is closed (step 382); and, sending a confirmation 384 via wireless communication to second handheld computer 364 that the package has been delivered successfully (step 386).

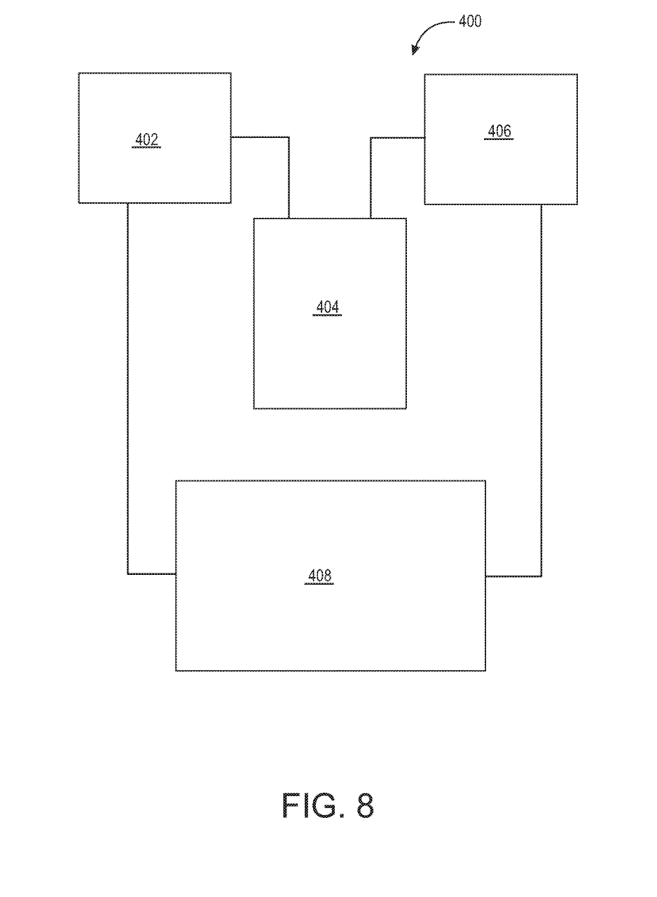

FIG. 8 is a high level schematic representation of system 400 and the communication channels utilized by the various devices throughout the methods recited herein. System 400 comprises first handheld computer 402, server 404, second handheld computer 406, and lock box 408. In an example embodiment of the methods recited herein, first handheld computer 402 is a handheld computer capable of short-range wireless communication e.g., Bluetooth®, radio frequency, infrared, and Zigbee® communication, as well as long-range wireless communications, e.g., radio frequency, cellular network communications, GPS, Wi-Fi, and Land Mobile Radio communications. In a preferred embodiment, first handheld device is a Dolphin 99EX handheld computer made by Honeywell® and used by many courier services in the United States. In an example embodiment server 404 is a typical server or CPU, which could be physical or cloud based and is used to store registration data discussed infra. In an example embodiment second handheld computer 406 can be any handheld computer capable of the short-range and long-range wireless communication protocols discussed supra; however, in a preferred embodiment second handheld computer 406 is a smart phone or tablet or other smart device. In an example embodiment, lock box 408 is any receptacle capable of receiving mail or a package, which utilizes short-range wireless communications to engage and disengage a short-range wireless locking mechanism. Certainly, lock box 408 may be device 100 recited supra, or any other porch box with wireless capabilities. Throughout the methods described supra, most of the communications are sent/received between lock box 408 and one of the handheld computers, i.e., first handheld computer 402 and second handheld computer 406. These communications between first handheld computer 402 and lock box 408, and second handheld computer 406 and lock box 408 act as an additional layer of theft proofing, i.e., since all of the communications with the lock box happen short-range, the opportunities to “hack” the locking mechanism over the internet are eliminated. Furthermore, first and second handheld computers 402 and 406 are both capable of sending and receiving long-range communications from server 404, or another source i.e., the vendor. Communications with server 404 can include but are not limited to, sending confirmation notifications to the vendor selling the item/package and to the recipient as well as registration information discussed infra.

The following description is an exemplary illustration of a delivery process from start to finish utilizing the lock box and methods described supra. A recipient/homeowner purchases, from a home improvement store or other department store, a lock box with wireless communication capabilities such as device 100 described supra. Within the owner's manual for the wirelessly enabled lock box, there is a QR code which, when scanned by a smart phone or tablet, brings the recipient to a web-based application which allows for the registration of the device with a courier entity, as well as provides instructions to initially pair the recipient's smart phone or tablet to the lock box via Bluetooth® pairing. After the recipient pairs the device with the lock box, the recipient registers the lock box with the courier. Registration allows a centralized server such as server 404, owned by the courier, to identify and store the residential information of the recipient along with the unique authentication code unique to that lock box. This unique authentication code can be the unique 48 bit address, commonly abbreviated as BD_ADDR which is usually presented in the form of a 12-digit hexadecimal value used in most Bluetooth® transactions. Alternatively, the server and/or lock box could be arranged to unlock using a unique authentication code, specific to the courier instead of the BD_ADDR code.

A recipient locates an item sold through an online vendor, e.g., https://www.amazon.com, etc., and places an order with that vendor. The recipient processes a credit card, debit card, gift card payment or some other form of payment, e.g., PayPal, bitcoin, etc., in order to purchase the item from the vendor. After the order is placed, the vendor contracts with a courier service, e.g., United States Postal Service, UPS, FedEx, etc., for the task of delivering the item from a warehouse, factory, or distribution facility to the recipient's preferred address. The recipient then chooses to ship the item to the recipient's residence, the residence of another, or to a professional address such as an office building.

Upon receiving the order information from the vendor for that particular order/item, the courier generates a unique shipment tracking number used to track the package from its place of origin to its final destination. The courier then proceeds to ship the item to its final destination, i.e., the location specified by the recipient, where the courier will encounter the lock box for the first time. The courier utilizes a handheld computer capable of wireless communication, e.g., first handheld computer 402 and pairs the handheld computer with the lock box. Pairing is a term of art associated with the process of establishing a connection between two Bluetooth® enabled devices. During the pairing process, the courier's handheld computer sends the unique authentication code, stored on the courier's server during registration, which correlates to the particular lock box assigned to that address or recipient name. In the event that successful pairing takes place and a unique authentication code is not sent to the locking mechanism, the lock box, after a predetermined time period, will “time out” the connection, i.e., terminate the pairing relationship between the locking mechanism and the courier's handheld computer. After receipt of a unique authentication code, the lock box then runs a check to determine if the unique authentication code stored in its internal memory matches the unique authentication code sent from the courier's handheld computer. If there is a match, a locking mechanism releases its wirelessly enabled lock and allows the courier to open the device and deposit the item. The locking mechanism then stores the physical device address, known as a MAC address of the handheld computer used to access the lock box. The lock box stores the MAC addresses it records in a log file within the internal memory of the locking mechanism along with date and time stamps relating to each time the box was accessed. Contemporaneously with the pairing process or shortly thereafter, the handheld computer uploads the unique shipment tracking number to the internal memory of the locking mechanism within the lock box. After the item is deposited, the courier closes the lock box and the locking mechanism reengages, locking the lock box and protecting the deposited item from theft. When the lock box senses with at least one sensor that it has been closed and the tracking number has been uploaded and stored, the lock box sends a notification to the courier's handheld computer which it in turn uses to notify by email, text message, SMS, or other long-range wireless communication, the vendor and the recipient, indicating that the item has been deposited and the lock box has been locked with the package safely inside.

When the recipient arrives home, the recipient finds the lock box in a locked state with the package inside. The recipient then proceeds with pairing their handheld computer to the lock box, if the recipient has not done so already. After pairing, the lock box requires the unique shipment tracking number as the wireless key that opens the locking mechanism. Similarly to the pairing process discussed above with respect to the courier's handheld computer, if no unique shipment tracking number has been sent, the lock box, after a predetermined time period, terminates the pairing relationship between the locking mechanism and the recipient's handheld computer. Upon the reopening of the lock box using the unique shipment tracking number, the locking mechanism stores in its log file the MAC address of the device used to access the lock box, as well as the date and time it was accessed. The log file is a critical component to ensuring customer satisfaction. Often, when items are lost in the delivery process, the recipient will attempt to claim that the item was never delivered. By utilizing the apparatus and methods recited herein, the log file keeps a record of the devices that access the lock box, as well as the date and time of that access, removing the inability of the vendor or courier from knowing what really happened. Utilizing the methods recited herein, the courier service can confirm/prove if the recipient has actually received the package or if the item was misplaced at some point in the delivery process.

Another benefit derived from use of the apparatus and methods recited herein, is portability and accessibility options that become available for courier services which reduce delivery time and increase efficiency. By allowing a customer/recipient to purchase a weather-resistant lock box such as device 100 discussed supra, the customer can place the lock box out by the side of the road, in an easement or portion of their property that is easily accessible by courier services. This allows the courier to deliver the package without leaving their delivery truck. This added benefit will increase delivery efficiency and reduce the physical strain on courier employees.

Thus it is seen that the objects of the invention are efficiently obtained, although changes and modifications to the invention should be readily apparent to those having ordinary skill in the art, which changes would not depart from the spirit and scope of the invention as claimed.

What is claimed is:

1. A device for receiving packages comprising:
a first receptacle comprising:
at least one sidewall;
a roof contiguous with the at least one sidewall;
a platform contiguous with the at least one sidewall, the platform further comprising a top surface and a bottom surface; and,
at least one open space between the roof and the top surface of the platform, the at least one open space operatively arranged to receive mail or a package; and,
a second receptacle comprising:
a first wall having a first upper edge and a first lower edge;
a second wall having a second upper edge and a second lower edge;
a third wall having a third upper edge and a third lower edge; and,
a fourth wall having a fourth upper edge and a fourth lower edge;
wherein the first wall, the second wall, the third wall, and the fourth wall are contiguous and arranged to create a closed space.

2. The device for receiving packages of claim 1 further comprising a base fixedly secured to the first lower edge, the second lower edge, the third lower edge, and the fourth lower edge, the base operatively arranged to receive a ballast material through a port.

3. The device for receiving packages of claim 2 wherein the ballast material is sand, water, antifreeze, or a combination of water and antifreeze.

4. The device for receiving packages of claim 2 wherein the first receptacle, the second receptacle, and the base are made of molded plastic.

5. The device for receiving packages of claim 1 wherein the second receptacle comprises a locking mechanism the locking mechanism is fixedly secured to the inside of the second receptacle and arranged to prevent unauthorized rotational displacement of the first receptacle about a hinge in a first rotational direction.

6. The device for receiving packages of claim 5 wherein the locking mechanism communicates with at least one handheld computer via wireless communication.

7. The device for receiving packages of claim 5 wherein the at least one handheld computer and the locking mechanism uses short-range wireless communication.

8. The device for receiving packages of claim 5 wherein the locking mechanism is fixedly secured to the inside of the first wall, proximate the first upper edge and within the closed space.

9. The device for receiving packages of claim 1 further comprising the hinge fixedly secured to the upper edge of the first wall and the bottom surface of the platform.

10. A method for securely delivering a package comprising:
receiving an order for an item to be delivered to a recipient;
obtaining a unique authentication code;
delivering the item to a location corresponding to the recipient;
unlocking a lock box at the location using the unique authentication code sent wirelessly to a locking mechanism within the lock box; and,
depositing the item in the lock box.

11. The method for securely delivering a package of claim 10 wherein the step of unlocking the lock box is achieved by sending the unique authentication code wirelessly from a handheld computer to the locking mechanism.

12. The method for securely delivering a package of claim 10 further comprising:
uploading a unique shipment tracking number wirelessly to the locking mechanism;
storing the unique shipment tracking number in a memory element within the locking mechanism; and,
locking the lock box after the item is deposited.

13. The method for securely delivering a package of claim 12 further comprising:
receiving a notification via wireless communication from the lock box confirming that the lock box has been closed and relocked; and,
sending a notification via wireless communication to the recipient informing the recipient that the package has been delivered successfully;
sending a notification via wireless communication to a vendor informing the vendor that the package has been successfully delivered.

14. The method for securely delivering a package of claim 10 wherein, the handheld computer uses short-range wireless communication to communicate with the locking mechanism.

15. A method for securely receiving a package comprising:
storing a first unique authentication code in at least one memory element within a locking mechanism of a lock box;
receiving a second unique authentication code sent from a first handheld computer;
storing the second unique authentication code in the at least one memory element within the locking mechanism;
comparing the first unique authentication code and the second authentication code;
unlocking the locking mechanism of the lock box if the first unique authentication code and the second unique authentication code match;
sensing with at least one sensor that the locking mechanism is disengaged when the lock box is opened;
receiving the package within the lock box;
sensing with at least one sensor that the locking mechanism is engaged when the lock box is closed; and,
sending a confirmation via wireless communication to the first handheld computer that the lock box is closed.

16. The method for securely receiving a package of claim 15 further comprising:
receiving a first unique shipment tracking number from the handheld computer;
storing the first unique shipment tracking number in the at least one memory element within the locking mechanism;
receiving a second unique shipment tracking number from a second handheld computer;
unlocking the locking mechanism if the first unique shipment tracking number and the second unique shipment tracking number match;
sensing with the at least one sensor that the locking mechanism is disengaged when the lock box is open; and,
sensing with the at least one sensor that the locking mechanism is engaged when the package is removed and the lock box is closed.

17. The method for securely receiving a package of claim 16 further comprising:
storing within the at least one memory element of the locking mechanism:
a first unique device identification code associated with the first handheld computer; and,
a second unique device identification code associated with the second handheld computer.

18. The method for securely receiving a package of claim 16 further comprising:
storing within the at least one memory element of the locking mechanism:
a first date and a first time associated with the receiving of the second unique authentication code sent from the first handheld computer; and,
a second date and a second time associated with the receiving of the unique shipment tracking number from the second handheld computer.

19. The method for securely receiving a package of claim 16 further comprising:
sending a confirmation via wireless communication to the second handheld computer that the package has been delivered when the at least one sensor is engaged after the package is removed and the lock box is closed.

20. The method for securely receiving a package of claim 16 wherein the first handheld computer and the second handheld computer use short-range wireless communication to communicate with the locking mechanism.
